(19) United States
(12) Patent Application Publication
(10) Pub. No.: US 2019/0076716 A1
(43) Pub. Date: Mar. 14, 2019

(54) ACTIVITY TRAINING SYSTEM

(71) Applicant: Intel Corporation, Santa Clara, CA (US)

(72) Inventors: Wei Han Chiou, TAIPEI CITY (TW); Yung Hsuan Lin, NEW TAIPEI CITY (TW)

(21) Appl. No.: 15/702,470

(22) Filed: Sep. 12, 2017

(51) Int. Cl. A63B 69/00; G08B 6/00; A63B 71/06; G09B 19/00; A63B 24/00; A63B 71/00

(52) U.S. Cl. CPC A63B 69/00; G08B 6/00; A63B 71/0619; G08B 25/10; A63B 24/0062; A63B 71/0054; G09B 19/0038

(57) ABSTRACT

Systems and methods for providing an activity training system are provided herein. A footbed system for activity instruction includes a support material; a microcontroller embedded in the support material; a plurality of haptic vibrators coupled to the microcontroller, the haptic vibrators disposed in the support material and configured to provide haptic feedback via a foot of a user; wherein the microcontroller is to: receive force sensor readings from a plurality of force sensors of a remote footbed system, the force sensor readings caused by a user of the remote footbed system changing their body position; and activate a subset of the plurality of haptic vibrators to provide haptic feedback, the haptic feedback corresponding to locations of the force sensor readings in the remote footbed system.

### TECHNICAL FIELD

Embodiments described herein generally relate to sensors and in particular, to an activity training system.

### BACKGROUND

There is a high learning curve in many sports and activities. Sports like skiing, snowboarding, surfing, or figure skating require a combination of balance, strength, and awareness. In many cases learning activities such as these involves many attempts where failures may result in injury.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating a footbed of footwear, according to an embodiment;

FIG. 2 is circuit diagram illustrating a footbed, according to an embodiment;

FIG. 3 is a diagram illustrating an example use case, according to an embodiment;

FIG. 4 is a diagram illustrating the use of networked footbeds, according to an embodiment;

FIG. 5 illustrates a scenario where a student encounters trouble, according to an embodiment;

FIG. 6 is a flowchart illustrating a method for providing activity instruction, according to an embodiment;

FIG. 7 is a flowchart illustrating a method for providing activity instruction, according to an embodiment; and

FIG. 8 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Many activities are dangerous to the unskilled. Some of the more dangerous activities are also some of the more difficult ones to master. Activities such as downhill skiing involve a situation where a participant may achieve very fast speeds where a fall may result in a broken leg, sprained wrist, concussion, or worse. With coaches and trainers, some of the training time may be reduced. However, it is difficult to coach a participant in a fast-paced activity while the participant is active in the activity. What is needed is a system to provide better instruction to a student who is learning an activity.

Activities may include, but are not limited to sports, hobbies, interests, recreations, or actions. Activities include skiing, running, dancing, snowboarding, skating, water skiing, golf, martial arts, baseball, cycling, and the like. Some activities may be team activities, such as volleyball, while others may he considered individual activities, such as hitting a baseball. In general, the systems and methods described herein may be applied to any activity where the participant uses their feet as support. As such, activities such as swimming or skydiving may not lend themselves to the benefits of the systems and methods described here.

In many activities, the student learns by mimicking the actions of the instructor. One downside to traditional instruction is that the student has to watch the instructor and then internalize the instructor's movements and translate them to their own. Young students are less able to do this because they do not possess the same body awareness as older adolescents or adults. Similarly, students with learning impairments may have difficulty mimicking the actions of their instructor. Using sensors embedded in the instructor's footwear and actuators embedded in the student's footwear, the student is provided real-time sensory assistance to help mimic the actions of the instructor. As the instructor moves, their movement is communicated to the student's footwear and the student is provided haptic cues to assist the student to move in the same form.

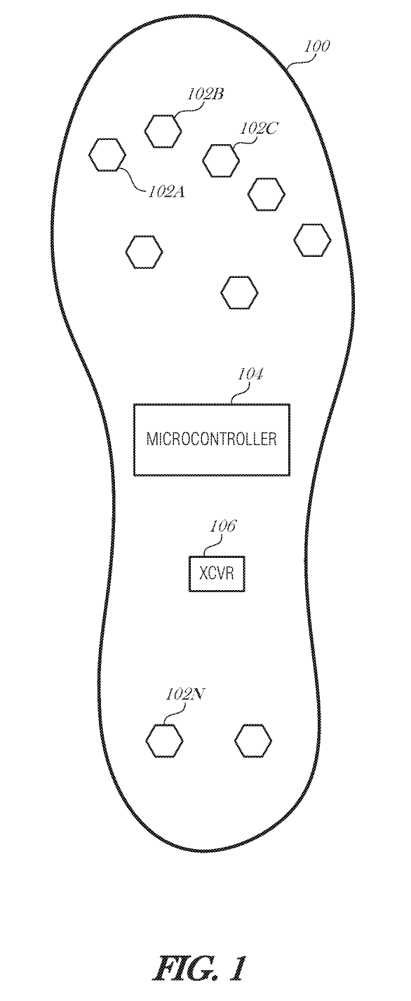

FIG. 1 is a diagram illustrating a footbed 100 of footwear, according to an embodiment. The footbed 100 includes an array of sensors 102A, 102B, 102C, . . . , 102N (collectively referred to as 102) incorporated into a support material. The support material may be of various types of materials, such as foam, rubber, cork, leather, cloth, layers of such materials, or the like. The footbed 100 may be incorporated or placed into a variety of footwear that is appropriate to the activity. For instance, the footbed 100 may be incorporated into a ski boot, a hockey skate, a running shoe, or the like. The footbed 100 may be removable so that the user is able to move the footbed 100 from their shoes to their snowboard boots, for example. The footbed 100 may be shaped to act as an orthotic support. The footbed 100 may be used in place of a typical insole or may be used on top of, or underneath, another insole. For instance, the footbed 100 may be provided as an after-market product that a person may insert into their existing shoes, on top of their existing insole.

The sensors 102 may include a haptic vibrator and a force-sensing resistor, in an embodiment. In an aspect, to make a universal footbed 100, a manufacturer may provide a footbed 100 that is configurable to operate in instructor mode to capture the instructor's movements, or student mode to provide haptic feedback to the student. When operating in instructor mode, the haptic actuators, vibrators, or motors may be disabled so that the instructor is not distracted by haptic vibration. When operating in student mode, the force-sensing resistor may be disabled.

In another aspect, the sensor 102 may include only one of the haptic vibrator or the force-sensing resistor. When the sensor 102 only includes a haptic vibrator, then the footbed 100 may be used by a student. Conversely, footbeds 100 that have sensors 102 that include force-sensing resistors may be used by an instructor.

In some embodiments, student-oriented footbeds 100 may include both the haptic vibrator and force-sensing resistor, where the force-sensing resistor may be used to detect the amount of force the student is applying in order to dynamically disable the haptic response. The disabling may be used, for example, when the student has applied an appropriate amount of force and does not need to apply more.

Haptic vibrators may include haptic actuators, drivers, engines, and the like to produce a haptic signal to the user. Haptic vibrators may be based on various techniques, including but not limited to a solenoid, piezo actuators, eccentric rotating mass, or linear resonant actuators. Depending on the form factor of the footbed 100 and other design and construction considerations, the haptic vibrators used in the sensors 102 may be of various types, either all uniform within the footbed 100 or multiple types within the footbed 100.

Force-sensing resistors may measure the amount of force applied. A conventional force sensing resistor is constructed by sandwiching a force-sensitive material that decreases resistance with an increase in force, between two conductive electrodes. Measuring the amount of resistance across the force-sensitive material as force is applied, the resistance decreases, and the force is measured as a function of the resistance.

The sensors 102 may be arranged in a manner so that the instructor's movements are captured accurately and logically. The sensors 102 may be placed at or near where the joints in the foot are normally located with respect to the footbed 100. While being located ventrally and dorsally on the footbed 100 (e.g., toward the toes and toward the heel), the sensors 102 may also be located laterally and medially (e.g., outside and inside edges of the foot). More or fewer sensors 102 may be used according to available space within a footbed 100, cost considerations, manufacturing considerations, and use considerations. For example, for a one-time use slipper to learn how to dance, fewer sensors may be used to reduce cost. Alternatively, for a professional athlete striving for perfection over a long season, many more sensors 102 may be used to provide additional sensory granularity (for both the trainer and the trainee).

The sensors 102 may be communicatively coupled to a controller 104 in or near the footbed 100. The controller 104 may be a system on chip (SoC) unit. The controller 104 may include logic, memory, and other components to control the sensors 102, for instance to actuate a haptic vibrator at a particular sensor 102. The controller 104 may also include an accelerometer, gyroscope, real-time clock, and other circuitry to perform the operations described herein. The controller 104 may be coupled to a wireless transceiver 106 to transmit and receive data over a wireless communication network. Optionally, the controller 104 and wireless transceiver 106 may be incorporated into the same package or on the same die, resulting in an SoC.

The transceiver 106 may be configured to transmit over various wireless networks, such as a Wi-Fi network (e.g., according to the IEEE 802.11 family of standards) or a cellular network (e.g., a network designed according to the Long-Term Evolution (LTE), LTE-Advanced, 5G or Global System for Mobile Communications (GSM) families of standards, or the like).

A user may have multiple footbeds 100 (e.g., one for each foot), and the instructor and student may each have their own set of footbeds 100. Each controller 104 of each footbed 100 is able to communicate with other controllers 104 (either of the pair of footbeds of the same user or amongst footbeds of several users) via wireless networks. The footbeds 100 are able to exchange pressure data, location data (e.g., GPS, positioning system, etc.), speed data, or distance data. Between an instructor and one or more students, the instructor's left foot footbed 100 may be mapped to the left foot footbeds 100 of the students. Similarly, the instructor's right foot footbed 100 may be mapped to the right foot footbeds 100 of the students. Mapping may be inverted, for example to accommodate a snowboarder who is goofy footed (right foot in front of left on board) with an instructor who is regular footed (left foot in front of right on board). Data may be translated so that the goofy-footed student may follow along in the instruction.

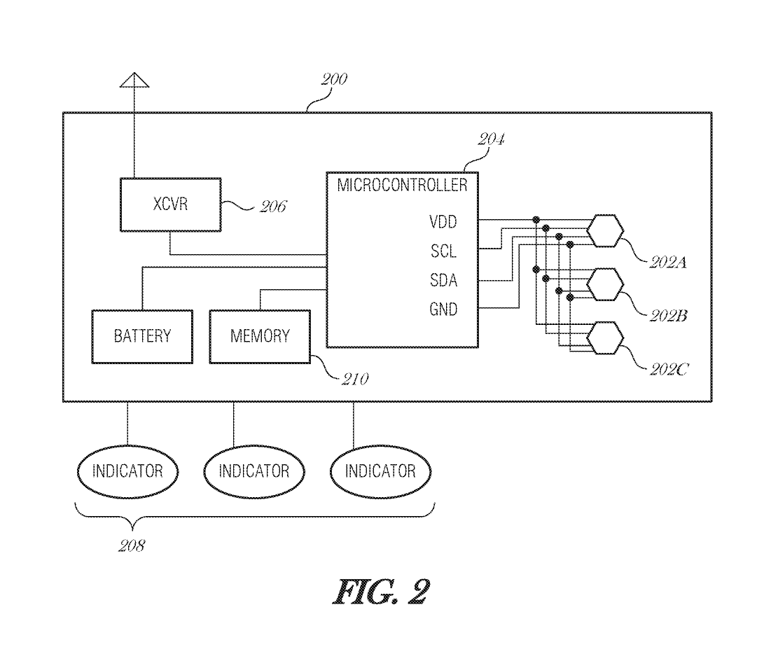

FIG. 2 is circuit diagram illustrating a footbed 200, according to an embodiment. The footbed 200 includes sensors 202A, 202B, 202C (collectively referred to as 202) coupled to a microcontroller 204. The footbed 200 may incorporate or be coupled to one or more indicators 208. A transceiver 206 may be configured to provide a wireless networking communication system. The wireless networking communication system may use one or more of a variety of protocols or technologies, including Wi-Fi, 3G, and 4G LTE/LTE-A, WiMAX networks, Bluetooth, near field communication (NEC), or the like.

The indicators 208 may include various types of lights (e.g., light-emitting diode (LED), incandescent, etc.). The lights may be colored using a shield, lens, or cover. In the case of LED lights, the lights may be colored based on the type or material used to make up the junction. The indicators 208 may be used to indicate a communication connectivity state (e.g., wireless connection active), power status, battery status, or other state information. The indicators 208 may be incorporated into the housing of the footbed 200.

The microcontroller 204 provides an external supply voltage (Vdd) to each of the sensors 202. In the embodiment illustrated in FIG. 2 the sensors 202 are force resistor sensors with haptic vibrators.

The microcontroller 204, first sensor 202A, second sensor 202B, third sensor 202C, transceiver 206, and memory 210 are understood to encompass tangible entities that are physically constructed, specifically configured (e.g., hardwired), or temporarily (e.g., transitorily) configured (e.g., programmed) to operate in a specified manner or to perform part or all of any operations described herein. Such tangible entitles may be constructed using one or more circuits, such as with dedicated hardware (e.g., field programmable gate arrays (FPGAs), logic gates, graphics processing unit (GPU), a digital signal processor (DSP), etc.). As such, the tangible entities described herein may be referred to as circuits, circuitry, processor units, subsystems, or the like.

The sensors 202 are arranged to detect changes in pressure applied by a user. The microcontroller 204 may capture the sensor data output by the sensors 202, and store it in memory 210. The microcontroller 204 may cause the transceiver 206 to transmit force or pressure values to other footbeds, such as those of students.

The transceiver 206 may be configured to transmit over various wireless networks, such as a Wi-Fi network (e.g., according to the IEEE 802.11 family of standards), cellular network, such as a network designed according to the Long-Term Evolution (LTE), LTE-Advanced, 5G or Global System for Mobile Communications (GSM) families of standards, or the like.

Communication between footbeds 200 may be initiated by a user with an auxiliary device. For instance, an app on a mobile phone may be used to pair a student's footbeds with an instructor's footbeds. The pairing may be performed over a short-range communication protocol, such as Bluetooth, or over a longer range communication protocol, such as Wi-Fi.

A student footbed 200 is arranged to receive force or pressure data from an instructor footbed 200, determine existing force that the user is applying to the corresponding sensors 202 in the student footbed 200, and cause haptic vibrators to actuate depending on whether enough force is being applied to the corresponding sensors 202 in the student's footbed 200.

A less intelligent implementation of a student footbed 200 does not adjust haptic output based on any existing force being applied by the student, and instead merely provides the haptic output to the corresponding haptic vibrators based on the instructor's force sensor readings. In this situation, the student may not understand how much force to apply and when enough is enough. However, a student is likely to be able to adapt to the situation to mitigate and manage their performance, for instance to not apply so much force as to fall. Additionally, this form factor may result in business advantages, for example, the production cost of such a unit may be lower, resulting in a more costly product and wider distribution.

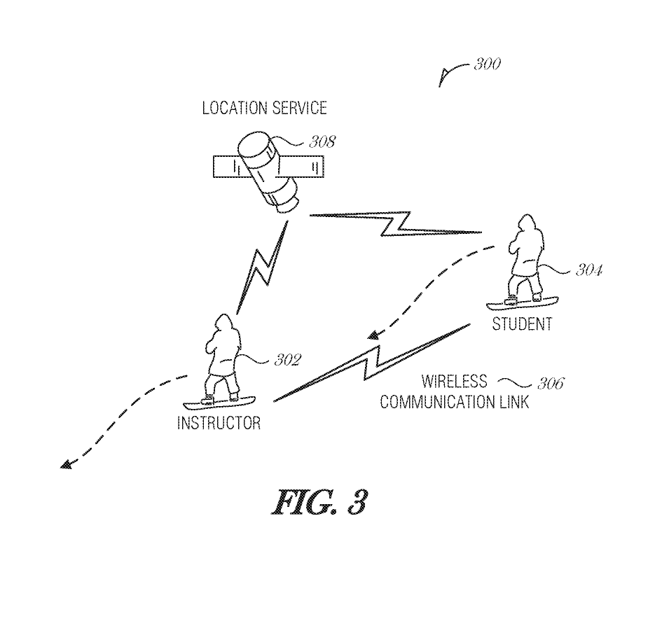

FIG. 3 is a diagram illustrating an example use case, according o an embodiment. In the use case 300, an instructor 302 is providing instruction to a student 304. Although only one student 304 is illustrated in FIG. 3, it is understood that several students may be in the same instruction led by the instructor 302. The instructor 302 has two footbeds, such as those described in FIGS. 1-2, that are communicatively coupled to the student's footbeds. The footbeds may be connected with wireless network 306, which may be a Wi-Fi, Bluetooth, ZigBee, or cellular network, for example. Additionally, the footbeds may be connected to a location service 308, which may be a global positioning service (GPS) network, GLONASS, Wi-Fi positioning system, or the like.

The instructor 302 may begin descent down the slope, the student 304 may follow. As the instructor 302 demonstrates a skill to the student 304, the student 304 is able to visually observe the instructor 302 and then at the appropriate time, also feel the instructor's motions via the haptic vibrators in the student's boots. When the student mimics the motions by following the haptic vibrations, the student 304 will roughly follow the same path as the instructor 302.

The instructor's footbed obtains location data, time, and force sensing data, which may be sampled periodically. The sampling period may be every second, every half second, or other interval. Using the location data and time, the instructor's speed may be calculated. Distance may also be calculated by multiplying the speed and time.

The instructor's footbeds may transmit information to the student's footbeds. The instructor's footbeds may calculate accurate speed and distance of the instructor 302 using location data and accelerometer/gyroscopes. The instructor's microcontroller/transceiver in boots will continue to send location data, sliding distance, distance between instructor 302 and student 304, force pressure data with each sensor, speed of each time stamp to student's footbed every second, etc. Such data may be used to calculate correct time, force, and position for the student's haptic vibrator to start vibrating with specific power. The student 304 is able to get real-time feedback via the haptic vibrators to guide him on how to put force on specific points of the boots in order to imitate the instructor's movements on specific slope/terrain.

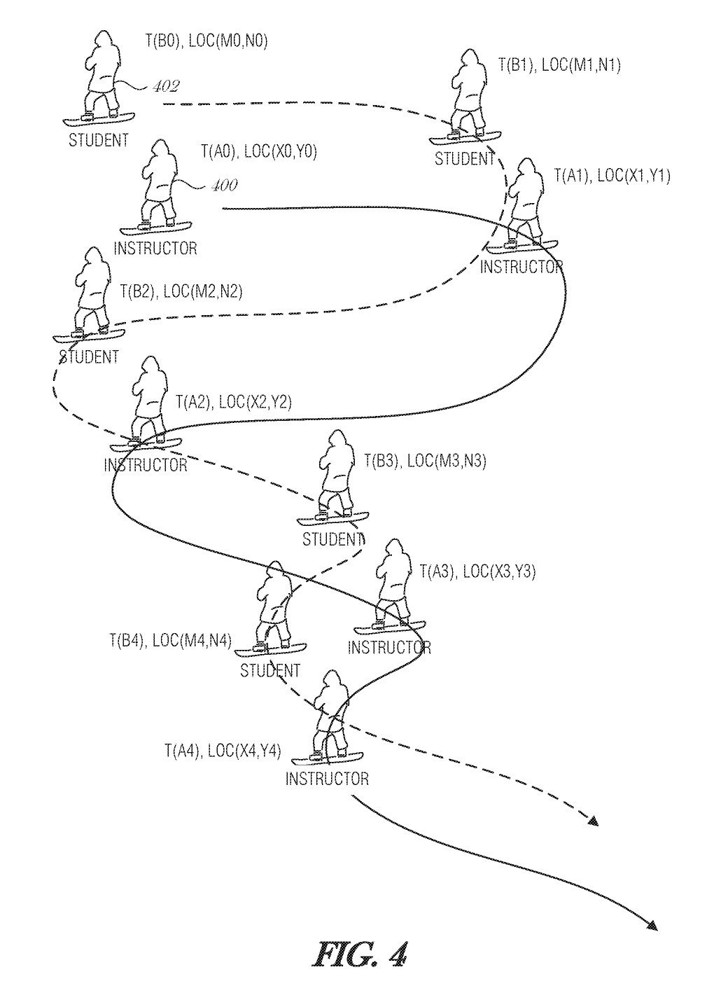

FIG. 4 is a diagram illustrating the use of networked footbeds, according to an embodiment. The instructor 400 begins at the top of the ski slope at time T(a0) and position Loc(x0, y0). The student 402 begins at a corresponding position Loc(m0, n0) at some time T(b0). The student's corresponding position may be at some offset position, such as several feet above the instructor 400 on the slope. Alternatively, the student's corresponding position may be at approximately the same position as the instructor 400, but at a different point in time. For instance, the instructor 400 may begin traversing the slope and then the student may move to begin traversing the slope at approximately the same position that the instructor 402 left from.

The instructor's footbeds begin transmitting location data, speed data, force data, and time data to one or more student's footbeds. Using the location, speed, and time data, the student's footbeds are able to calculate when the student 402 is a corresponding location and actuate the haptic vibrators. In some embodiments, the haptic vibrators are actuated in anticipation of the student 402 arriving at a location, to provide the student 402 with enough time to react to the vibration and produce the same type of motion that the instructor 400 demonstrated.

Three possible delay time periods may be accounted for in a delta T. The first delay time period is to account for how long it take for a human being's brain to send a signal to the feet, ΔT1.

The second delay time period is to account for electronic transmission time. For example, the amount of time it takes for the instructor's force sensor to transmit data to the microcontroller, plus the time it takes for the microcontroller to transmit data to the transceiver, and then for the transceiver to transmit the data to the receiving student's footbed. The second delay time period is referred to as ΔT2.

The third delay time period is to account for the time it takes for the student's transceiver, microcontroller, and haptic driver to receive and process the signal. The third delay time period is referred to as ΔT3.

Based on experimentation and observation, ΔT(total)=ΔT1(brain, feet)+ΔT2(SoC+Wireless)+ΔT3(SoC)˜=1 sec. As a result, the student's microcontroller has to vibrate one second before the student 402 reached Loc(m1, n1) to imitate the instructor's motion when the instructor 400 at Loc(x1, y1) location. The student's speed is calculated using ΔLocation/time, where ΔLocation may be calculated with location or positioning systems available to the student's microcontroller in their footbed. For example, the footbed may use GPS, which may be assisted with a Wi-Fi positioning system for better location accuracy. Based on the student's speed, an estimated time before the student 420 reaches the Loc(m1, n1) may be determined. Using the ΔT(total), the student's haptic vibrators may be actuated ahead of time to allow the student 402 to react accordingly. Using speed in combination with location, the student 402 is able to proceed slower than the instructor 400, but still obtain haptic notifications at an appropriate time.

The duration of the vibration at the student's footbed may be various amounts. For more experienced students, a 0.5 sec vibration duration may be used. The short notice allows better accuracy during performance. A longer vibration duration, such as 2.0 sec may be used to provide additional notice to the student 402 and allow the student 402 to make adjustments before making the move. For instance, a less experienced student 402 may have to gain their balance before making a turn indicated by the vibrations.

Following this calculation model, the student 402 may imitate the instructor 400 moving on slope and follow the instructor's track even if they are not in the same curving line, but have similar continuous curves in the slope.

While the example in FIG. 4 illustrates a live instructor 400, in some embodiments, a virtual instructor may be used. A virtual instructor may be loaded into the student's footbed system to provide the haptic guidance at appropriate times, so that the student 402 is able to emulate an instructor's previous run. The use of a virtual instructor provides the benefit of greater availability of instruction to a larger number of students. It also has the benefit of repeatability for the benefit of a student who wishes to repeatedly practice the same run. It may also attract more students to a particular sport or activity, if it is provided at lower cost than live instruction, or provides the student the ability to practice in private without being embarrassed to practice in front of a live instructor. Other benefits may be available as well, such as providing a challenge of a very skilled run to intermediate students, or providing instruction from distant or unavailable instructors.

The time, speed, and location data available to a student's footbed may be used for other use cases. For instance, continuing the example activity of snowboarding, the various data may be used as a safety mechanism.

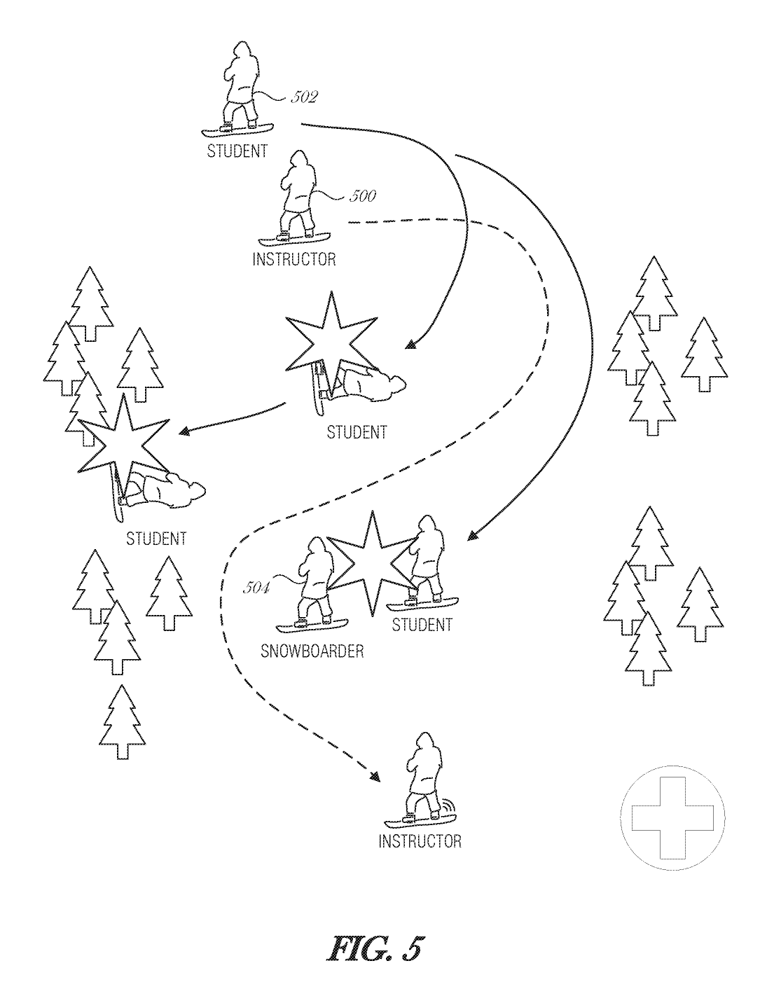

FIG. 5 illustrates a scenario where a student 502 encounters trouble, according to an embodiment. As the student 502 follows the instructor 500, the student's footbed is gathering location, speed, and time data. If the location, speed, or time data indicates that the student 502 has encountered trouble, a signal may be sent to the instructor 500. The signal may activate some or all of the haptic vibrators in the instructor's footbed(s).

In a first situation, the student 502 may fall down or stop. Location or speed determination at the student's footbed(s) allows the footbed(s) to call for help or alert the instructor 500. The instructor's footbed(s) may vibrate in a certain manner to alert the instructor 500. In an embodiment, the instructor's footbeds vibrate with all of the haptic vibrators actuated for an extended period (e.g., 30 seconds). Other vibration patters, such as pulsing in a certain manner, or use of specific haptic vibrators, such as alternatively pulsing the front and rear of the feet, may be used. The haptic vibration for alerting the instructor 500 may be configured by the instructor 500, a system administrator, or the manufacturer of the footbed.

In another situation, the student 502 may traverse out of a valid area. For instance, the student 502 may go off of the ski slope or snowboarding hill. In such a case, the student 502 may have lost control and veered off course. This may be dangerous because of ungroomed snow, collision hazards, or cliffs. The fact that the student 502 navigated off course may also indicate that the student 502 is having a medical emergency, is out of control, or another issue. The student's location and speed may be used to determine that the student 502 is in trouble. For instance, if the student's speed was 10 miles per hour and suddenly changed to motionless, the sudden change in velocity may indicate a collision. Similar to the first situation, the instructor 500 may be alerted of such a situation using haptic vibration patterns.

In another situation, the student 502 may be out of control and about to run into the instructor 500 or another person on the slope (e.g., snowboarder 504). The potential collision may be determined using location and speed inThrmation obtained from the student's footbed(s) and the other person's footbed(s). Haptic vibration alerts may be used to alert the student 502 and/or the instructor 500 or the person the student 502 is possibly going to collide with.

If a student 502, instructor 500, or other person with the intelligent footbeds is involved in a collision, then an emergency request may be transmitted to a response team. For instance, the emergency request may initiate a 911 phone call, transmit a message to a ski patrol, inform the person's friends or family, or otherwise issue a distress call. The collision may have been detected using an accelerometer, location system, speed determination, or other systems in the footbed(s).

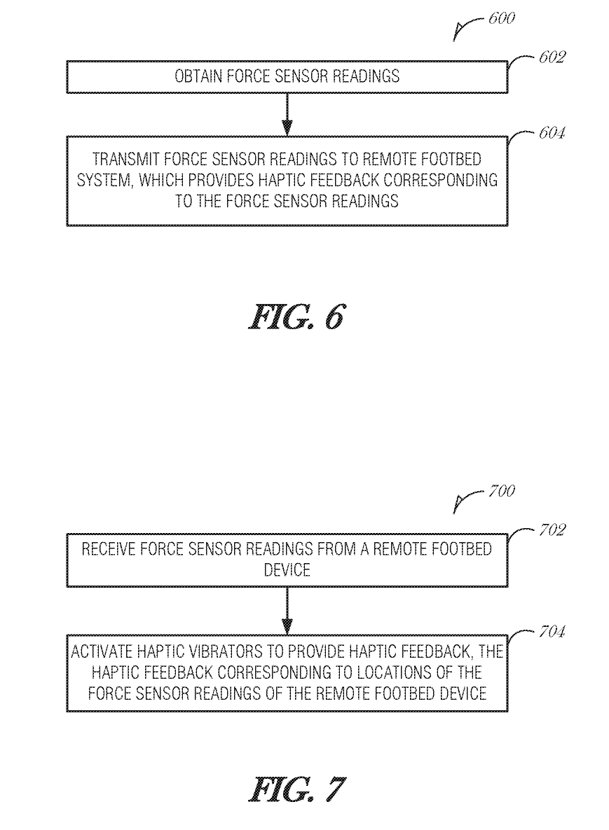

FIG. 6 is a flowchart illustrating a method 600 for providing activity instruction, according to an embodiment. At 602, force sensor readings from a plurality of force sensors coupled to the microcontroller are obtained at a microcontroller. The force sensors are disposed in a support material of a footbed system, and configured to detect force applied via a foot of a user using the footbed system.

At 604, the force sensor readings are transmitted to a remote footbed system, the remote footbed system configured to receive the force sensor readings from the footbed system and provide haptic feedback to a user of the remote footbed system, the haptic feedback corresponding to locations of the force sensor readings in the footbed system.

In an embodiment, the method 600 includes determining a geographic location of the footbed system. In a further embodiment, determining the geographic location comprises determining the geographic location with a global positioning system. In a related embodiment, determining the geographic location comprises determining the geographic location with a Wi-Fi positioning system.

In an erribodiment, the method 600 includes determining the speed that the footbed system is travelling. In a further erribodiment, determining the speed that the footbed system is travelling comprises obtaining a distance traveled, obtaining a time elapsed to travel the distance traveled, and dividing the distance traveled by the time elapsed to obtain the speed.

In an erribodiment, the method 600 includes receiving sensor information from the remote footbed system, and activating haptic vibrators on the footbed system to alert the user of the footbed system of the sensor information from the remote footbed system. In a further embodiment, the sensor information indicates that the user of the remote footbed system collided with an object, fell, or is in distress.

In an embodiment, the method 600 includes receiving a distress signal from the remote footbed system and activating haptic vibrators on the footbed system to alert the user of the footbed system of the distress signal from the remote footbed system. In a further embodiment, activating the haptic vibrators comprises activating all haptic vibrators in the footbed system.

FIG. 7 is a flowchart illustrating a method 700 for providing activity instruction, according to an embodiment. At 702, force sensor readings from a plurality of force sensors of a remote footbed system are received, the force sensor readings caused by a user of the remote footbed system changing their body position.

At 704, a subset of the plurality of haptic vibrators are activated to provide haptic feedback, the haptic vibrators disposed in a support material of a footbed system and configured to provide haptic feedback via a foot of a user the haptic feedback corresponding to locations of the force sensor readings in the remote footbed system.

In an embodiment, the method 700 includes determining a geographic location of the footbed system. In a further embodiment, wherein determining the geographic location comprises determining the geographic location with a global positioning system. In a related embodiment, wherein determining the geographic location comprises determining the geographic location with a Wi-Fi positioning system.

In an embodiment, the method 700 includes determining the speed that the footbed system is travelling, in a further embodiment, determining the speed that the footbed system is travelling comprises obtaining a distance traveled, obtaining a time elapsed to travel the distance traveled, and dividing the distance traveled by the time elapsed to obtain the speed.

In an embodiment, activating the subset of the plurality of haptic vibrators to provide haptic feedback, comprises determining that the user of the footbed system is approaching a corresponding position where the user of the remote footbed system changed their body position, and activating the subset of the plurality of haptic vibrators to assist the user of the footbed system to match the change in body position of the user of the remote footbed system.

In an embodiment, activating the subset of the plurality of haptic vibrators to provide haptic feedback, comprises activating the subset of the plurality of haptic vibrators using a lead time to allow the user of the footbed system to anticipate the change in the body position of the user of the remote footbed system. In a further embodiment, the lead time comprises a human reaction time component and an electronic transmission time component.

In an embodiment, the method 700 includes determining that the user of the footbed system has fallen and transmitting a distress call.

In an embodiment, determining that the user of the footbed system has fallen comprises accessing accelerometer or gyrometer data to determine a change in acceleration or a change in orientation that indicates that the user of the footbed system has fallen.

In an embodiment, transmitting the distress call comprises transmitting the distress call to the remote footbed system. In a related erribodiment, transmitting the distress call comprises transmitting the distress call to an emergency response system.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

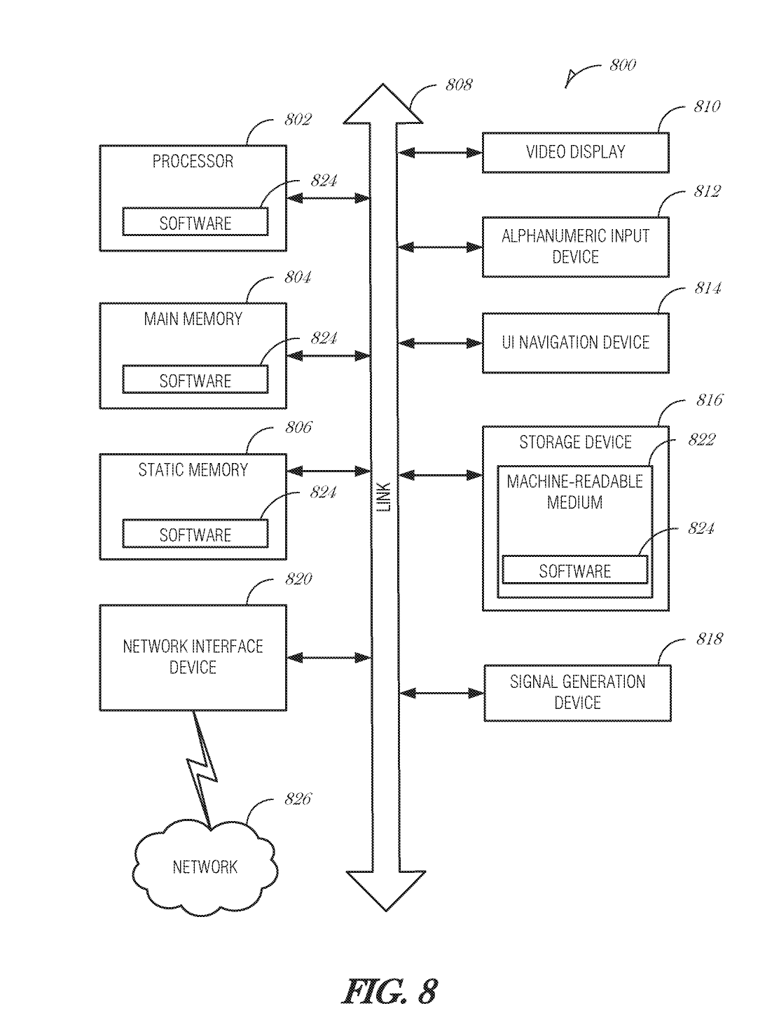

FIG. 8 is a block diagram illustrating a machine in fhe example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further optionally include a video display unit 810, an alphanumeric input device 812 (e.g., a keyboard), and a user interface (UI) navigation device 814 (e.g., a mouse). In an embodiment, the video display unit 810, input device 812 and UI navigation device 814 are incorporated into a touch screen display. The computer system 800 may additionally optionally include a storage device 816 (e.g., a drive unit), a signal generation device 818 (e.g., a speaker), a network interface device 820, and one or more sensors (not shown), such as a global positioning system (GPS) sensor, compass, accelerometer, gyrometer, magnetometer, infrared, camera, Hall effect magnetic sensor, ultrasound, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a footbed system for activity instruction, the system comprising: a support material; a microcontroller embedded in the support material; a plurality of force sensors coupled to the microcontroller, the force sensors disposed in the support material and configured to detect force applied via a foot of a user; wherein the microcontroller is to: obtain force sensor readings from the plurality of force sensors; and transmit the force sensor readings to a remote footbed system, the remote footbed system configured to receive the force sensor readings from the footbed system and provide haptic feedback to a user of the remote footbed system, the haptic feedback corresponding to locations of the force sensor readings in the footbed system.

In Example 2, the subject matter of Example 1 optionally includes a location system to determine a geographic location of the footbed system.

In Example 3, the subject matter of Example 2 optionally includes wherein the location system comprises a global positioning system.

In Example 4, the subject matter of any one or more of Examples 2-3 optionally include wherein the location system comprises a Wi-Fi positioning system.

In Example 5, the subject matter of any one or more of Examples 1-4 optionally include a speed determination circuit to determine the speed that the footbed system is travelling.

In Example 6, the subject matter of Example 5 optionally includes wherein to determine the speed that the footbed system is travelling, the speed determination circuit: obtains a distance traveled; obtains a time elapsed to travel the distance traveled; and divides the distance traveled by the time elapsed to obtain the speed.

In Example 7, the subject matter of any one or more of Examples 1-6 optionally include wherein the microcontroller is to: receive sensor information from the remote footbed system; and activate haptic vibrators on the footbed system to alert the user of the footbed system of the sensor information from the remote footbed system.

In Example 8, the subject matter of Example 7 optionally includes wherein the sensor information indicates that the user of the remote footbed system collided with an object, fell, or is in distress.

In Example 9, the subject matter of any one or more of Examples 1-8 optionally include wherein the microcontroller is to: receive a distress signal from the remote footbed system; and activate haptic vibrators on the footbed system to alert the user of the footbed system of the distress signal from the remote footbed system.

In Example 10, the subject matter of any one or more of Examples 7-9 optionally include wherein to activate the haptic vibrators, the microcontroller is to: activate all haptic vibrators in the foothed system.

Example 11 is a method of providing activity instruction, the method comprising: obtaining, at a microcontroller, force sensor readings from a plurality of force sensors coupled to the microcontroller, the force sensors disposed in a support material of a footbed system, and configured to detect force applied via a foot of a user using the footbed system; and transmitting the force sensor readings to a remote footbed system, the remote footbed system configured to receive the force sensor readings from the footbed system and provide haptic feedback to a user of the remote footbed system, the haptic feedback corresponding to locations of the force sensor readings in the footbed system.

In Example 12, the subject matter of Example 11 optionally includes determining a geographic location of the footbed system.

In Example 13, the subject matter of Example 12 optionally includes wherein determining the geographic location comprises determining the geographic location with a global positioning system.

In Example 14, the subject matter of any one or more of Examples 12-13 optionally include wherein determining the geographic location comprises determining the geographic location with a positioning system.

In Example 15, the subject matter of any one or more of Examples 11-14 optionally include determining the speed that the footbed system is travelling.

In Example 16, the subject matter of Example 15 optionally includes wherein determining the speed that the footbed system is travelling comprises: obtaining a distance traveled; obtaining a time elapsed to travel the distance traveled; and dividimg the distance traveled by the time elapsed to obtain the speed.

In Example 17, the subject matter of any one or more of Examples 11-16 optionally include receiving sensor information from the remote footbed system; and activating haptic vibrators on the footbed system to alert the user of the footbed system of the sensor information from the remote footbed system.

In Example 18, the subject matter of Example 17 optionally includes wherein the sensor information indicates that the user of the remote footbed system collided with an object, fell, or is in distress.

In Example 19, the subject matter of any one or more of Examples 11-18 optionally include receiving a distress signal from the remote footbed system; and activating haptic vibrators on the footbed system to alert the user of the footbed system of the distress signal from the remote footbed system.

In Example 20, the subject matter of any one or more of Examples 17-19 optionally include wherein activating the haptic vibrators comprises activating all haptic vibrators in the footbed system.

Example 21 is at least one machine-readable medium including instructions, which when executed by a machine, cause the machine to perform operations of any of the methods of Examples 11-20.

Example 22 is an apparatus comprising means for performing any of the methods of Examples 11-20.

Example 23 is an apparatus for providing activity instruction, the apparatus comprising: means for obtaining, at a microcontroller, force sensor readings from a plurality of force sensors coupled to the microcontroller, the force sensors disposed in a support material of a footbed system, and configured to detect force applied via a foot of a user using the footbed system; and means for transmitting the force sensor readings to a remote footbed system, the remote footbed system configured to receive the force sensor readings from the footbed system and provide haptic feedback to a user of the remote footbed system, the haptic feedback corresponding to locations of the force sensor readings in the footbed system.

In Example 24, the subject matter of Example 23 optionally includes means for determining a geographic location of the footbed system.

In Example 25, the subject matter of Example 24 optionally includes wherein the means for determining the geographic location comprise means for determining the geographic location with a global positioning system.

In Example 26, the subject matter of any one or more of Examples 24-25 optionally include wherein the means for determining the geographic location comprise means for determining the geographic location with a Wi-Fi positioning system.

In Example 27, the subject matter of any one or more of Examples 23-26 optionally include means for determining the speed that the footbed system is travelling.

In Example 28, the subject matter of Example 27 optionally includes wherein the means for determining the speed that the footbed system is travelling comprise: means for obtaining a distance traveled; means for obtaining a time elapsed to travel the distance traveled; and means for dividing the distance traveled by the time elapsed to obtain the speed.

In Example 29, the subject matter of any one or more of Examples 23-28 optionally include means for receiving sensor information from the remote footbed system; and means for activating haptic vibrators on the footbed system to alert the user of the footbed system of the sensor information from the remote footbed system.

In Example 30, the subject matter of Example 29 optionally includes wherein the sensor information indicates that the user of the remote footbed system collided with an object, fell, or is in distress,

In Example 31, the subject matter of any one or more of Examples 23-30 optionally include means for receiving a distress signal from the remote footbed system; and means for activating haptic vibrators on the footbed system to alert the user of the footbed system of the distress signal from the remote footbed system.

In Example 32, the subject matter of any one or more of Examples 29-31 optionally include wherein the means for activating the haptic vibrators comprise means for activating all haptic vibrators in the footbed system.

Example 33 is at least one machine-readable medium including instructions for providing activity instruction, which when executed by a machine, cause the machine to perform the operations comprising: obtaining, at a microcontroller, force sensor readings from a plurality of force sensors coupled to the microcontroller, the force sensors disposed in a support material of a footbed system, and configured to detect force applied via a foot of a user using the footbed system; and transmitting the force sensor readings to a remote footbed system, the remote footbed system configured to receive the force sensor readings from the footbed system and provide haptic feedback to a user of the remote footbed system, the haptic feedback corresponding to locations of the force sensor readings in the footbed system.

In Example 34, the subject matter of Example 33 optionally includes determining a geographic location of the footbed system.

In Example 35, the subject matter of Example 34 optionally includes wherein determining the geographic location comprises determining the geographic location with a global positioning system.

In Example 36, the subject matter of any one or more of Examples 34-35 optionally include wherein determining the geographic location comprises determining the geographic location with a Wi-Fi positioning system.

In Example 37, the subject matter of any one or more of Examples 33-36 optionally include determining the speed that the footbed system is travelling.

In Example 38, the subject matter of Example 37 optionally includes wherein determining the speed that the footbed system is travelling comprises: obtaining a distance traveled; obtaining a time elapsed to travel the distance traveled; and dividimg the distance traveled by the time elapsed to obtain the speed.

In Example 39, the subject matter of any one or more of Examples 33-38 optionally include receiving sensor information from the remote footbed system; and activating haptic vibrators on the footbed system to alert the user of the footbed system of the sensor information from the remote footbed system.

In Example 40, the subject matter of Example 39 optionally includes wherein the sensor information indicates that the user of the remote footbed system collided with an object, fell, or is in distress.

In Example 41, the subject matter of any one or more of Examples 33-40 optionally include receiving a distress signal from the remote footbed system; and activating haptic vibrators on the footbed system to alert the user of the footbed system of the distress signal from the remote footbed system.

In Example 42, the subject matter of any one or more of Examples 39-41 optionally include wherein activating the haptic vibrators comprises activating all haptic vibrators in the footbed system.

Example 43 is a footbed system for activity instruction, the system comprising: a support material; a microcontroller embedded in the support material; a plurality of haptic vibrators coupled to the microcontroller, the haptic vibrators disposed in the support material and configured to provide haptic feedback via a foot of a user; wherein the microcontroller is to: receive force sensor readings from a plurality of force sensors of a remote footbed system, the force sensor readings caused by a user of the remote footbed system changing their body position; and activate a subset of the plurality of haptic vibrators to provide haptic feedback, the haptic feedback corresponding to locations of the force sensor readings in the remote footbed system.

In Example 44, the subject matter of Example 43 optionally includes a location system to determine a geographic location of the footbed system.

In Example 45, the subject matter of Example 44 optionally includes wherein the location system comprises a global positioning system.

In Example 46, the subject matter of any one or more of Examples 44-45 optionally include wherein the location system comprises a Wi-Fi positioning system.

In Example 47, the subject matter of any one or more of Examples 43-46 optionally include a speed determination circuit to determine the speed that the footbed system is travelling.

In Example 48, the subject matter of Example 47 optionally includes wherein to determine the speed that the footbed system is travelling, the speed determination circuit: obtains a distance traveled; obtains a time elapsed to travel the distance traveled; and divides the distance traveled by the time elapsed to obtain the speed.

In Example 49, the subject matter of any one or more of Examples 43-48 optionally include wherein to activate the subset of the plurality of haptic vibrators to provide haptic feedback, the microcontroller is to: determine that the user of the footbed system is approaching a corresponding position where the user of the remote footbed system changed their body position; and activate the subset of the plurality of haptic vibrators to assist the user of the footbed system to match the change in body position of the user of the remote footbed system.

In Example 50, the subject matter of any one or more of Examples 43-49 optionally include wherein to activate the subset of the plurality of haptic vibrators to provide haptic feedback, the microcontroller is to: activate the subset of the plurality of haptic vibrators using a lead time to allow the user of the footbed system to anticipate the change in the body position of the user of the remote footbed system.

In Example 51, the subject matter of Example 50 optionally includes wherein the lead time comprises a human reaction time component and an electronic transmission time component.

In Example 52, the subject matter of any one or more of Examples 43-51 optionally include wherein the microcontroller is to: determine that the user of the footbed system has fallen; and transmit a distress call.

In Example 53, the subject matter of Example 52 optionally includes wherein to determine that the user of the footbed system has fallen, the microcontroller is to: access accelerometer or pyrometer data to determine a change in acceleration or a change in orientation that indicates that the user of the footbed system has fallen.

In Example 54, the subject matter of any one or more of Examples 52-53 optionally include wherein to transmit the distress call, the microcontroller is to transmit the distress call to the remote footbed system.

In Example 55, the subject matter of Example 54 optionally includes wherein to transmit the distress call, the microcontroller is to transmit the distress call to an emergency response system.

Example 56 is a method of providing activity instruction, the method comprising: receiving force sensor readings from a plurality of force sensors of a remote footbed system, the force sensor readings caused by a user of the remote footbed system changing their body position; and activating a subset of the plurality of haptic vibrators to provide haptic feedback, the haptic vibrators disposed in a support material of a footbed system and configured to provide haptic feedback via a foot of a user; the haptic feedback corresponding to locations of the force sensor readings in the remote footbed system.

In Example 57, the subject matter of Example 56 optionally includes determining a geographic location of the footbed system.

In Example 58, the subject matter of Example 57 optionally includes wherein determining the geographic location comprises determining the geographic location with a global positioning system.

In Example 59, the subject matter of any one or more of Examples 57-58 optionally include wherein determining the geographic location comprises determining the geographic location with a positioning system.

In Example 60, the subject matter of any one or more of Examples 56-59 optionally include determining the speed that the footbed system is travelling.

In Example 61, the subject matter of Example 60 optionally includes wherein determining the speed that the footbed system is travelling comprises: obtaining a distance traveled; obtaining a time elapsed to travel the distance traveled; and dividing the distance traveled by the time elapsed to obtain the speed.

In Example 62, the subject matter of any one or more of Examples 56-61 optionally include wherein activating the subset of the plurality of haptic vibrators to provide haptic feedback, comprises: determining hat the user of the footbed system is approaching a corresponding position where the user of the remote footbed system changed their body position; and activating the subset of the plurality of haptic vibrators to assist the user of the footbed system to match the change in body position of the user of the remote footbed system.

In Example 63, the subject matter of any one or more of Examples 56-62 optionally include wherein activating the subset of the plurality of haptic vibrators to provide haptic feedback comprises: activating the subset of the plurality of haptic vibrators using a lead time to allow the user of the footbed system to anticipate the change in the body position of the user of the remote footbed system.

In Example 64, the subject matter of Example 63 optionally includes wherein the lead time comprises a human reaction time component and an electronic transmission time component.

In Example 65, the subject matter of any one or more of Examples 56-64 optionally include determining that the user of the footbed system has fallen; and transmitting a distress call.

In Example 66, the subject matter of Example 65 optionally includes wherein determining that the user of the footbed system has fallen comprises: accessing accelerometer or gyrometer data to determine a change in acceleration or a change in orientation that indicates that the user of the footbed system has fallen.

In Example 67, the subject matter of any one or more of Examples 65-66 optionally include wherein transmitting the distress call comprises transmitting the distress call to the remote footbed system.

In Example 68, the subject matter of any one or more of Examples 65-67 optionally include wherein transmitting the distress call comprises transmitting the distress call to an emergency response system.

Example 69 is at least one machine-readable medium including instructions, which when executed by a machine, cause the machine to perform operations of any of the methods of Examples 56-68.

Example 70 is an apparatus comprising means for performing any of the methods of Examples 56-68.

Example 71 is an apparatus for providing activity instruction, the apparatus comprising: means for receiving force sensor readings from a plurality of force sensors of a remote footbed system, the force sensor readings caused by a user of the remote footbed system changing their body position; and means for activating a subset of the plurality of haptic vibrators to provide haptic feedback, the haptic vibrators disposed in a support material of a footbed system and configured to provide haptic feedback via a foot of a user; the haptic feedback corresponding to locations of the force sensor readings in the remote footbed system.

In Example 72, the subject matter of Example 71 optionally includes means for determining a geographic location of the footbed system.

In Example 73, the subject matter of Example 72 optionally includes wherein the means for determining the geographic location comprise means for determining the geographic location with a global positioning system.

In Example 74, the subject matter of any one or more of Examples 72-73 optionally include wherein the means for determining the geographic location comprise means for determining the geographic location with a Wi-Fi positioning system.

In Example 75, the subject matter of any one or more of Examples 71-74 optionally include means for determining the speed that the footbed system is travelling.

In Example 76, the subject matter of Example 75 optionally includes wherein the means for determining the speed that the footbed system is travelling comprise: means for obtaining a distance traveled; means for obtaining a time elapsed to travel the distance traveled; and means for dividing the distance traveled by the time elapsed to obtain the speed.

In Example 77, the subject matter of any one or more of Examples 71-76 optionally include wherein the means for activating the subset of the plurality of haptic vibrators to provide haptic feedback, comprise: means for determining that the user of the footbed system is approaching a corresponding position where the user of the remote footbed system changed their body position; and means for activating the subset of the plurality of haptic vibrators to assist the user of the footbed system to match the change in body position of the user of the remote footbed system.

In Example 78, the subject matter of any one or more of Examples 71-77 optionally include wherein the means for activating the subset of the plurality of haptic vibrators to provide haptic feedback comprise: means for activating the subset of the plurality of haptic vibrators using a lead time to allow the user of the footbed system to anticipate the change in the body position of the user of the remote footbed system.

In Example 79, the subject matter of Example 78 optionally includes wherein the lead time comprises a human reaction time component and an electronic transmission time component.

In Example 80, the subject matter of any one or more of Examples 71-79 optionally include means for determining that the user of the footbed system has fallen; and means for transmitting a distress call.

In Example 81, the subject matter of Example 80 optionally includes wherein the means for determining that the user of the footbed system has fallen comprise: means for accessing accelerometer or gyrometer data to determine a change in acceleration or a change in orientation that indicates that the user of the footbed system has fallen.

In Example 82, the subject matter of any one or more of Examples 80-81 optionally include wherein the means for transmitting the distress call comprise means for transmitting the distress call to the remote footbed system.

In Example 83, the subject matter of any one or more of Examples 80-82 optionally include wherein the means for transmitting the distress call comprise means for transmitting the distress call to an emergency response system.

Example 84 is at least one machine-readable medium including instructions for providing activity instruction, which when executed by a machine, cause the machine to perform the operations comprising: receiving force sensor readings from a plurality of force sensors of a remote footbed system, the force sensor readings caused by a user of the remote footbed system changing their body position; and activating a subset of the plurality of haptic vibrators to provide haptic feedback, the haptic vibrators disposed in a support material of a footbed system and configured to provide haptic feedback via a foot of a user; the haptic feedback corresponding to locations of the force sensor readings in the remote footbed system.

In Example 85, the subject matter of Example 84 optionally includes determining a geographic location of the footbed system.

In Example 86, the subject matter of Example 85 optionally includes wherein determining the geographic location comprises determining the geographic location with a global positioning system.

In Example 87, the subject matter of any one or more of Examples 85-86 optionally include wherein determining the geographic location comprises determining the geographic location with a Wi-Fi positioning system.

In Example 88, the subject matter of any one or more of Examples 84-87 optionally include determining the speed that the footbed system is travelling.

In Example 89, the subject matter of Example 88 optionally includes wherein determining the speed that the footbed system is travelling comprises: obtaining a distance traveled; obtaining a time elapsed to travel the distance traveled; and dividing the distance traveled by the time elapsed to obtain the speed.

In Example 90, the subject matter of any one or more of Examples 84-89 optionally include wherein activating the subset of the plurality of haptic vibrators to provide haptic feedback, comprises: determining that the user of the footbed system is approaching a corresponding position where the user of the remote footbed system changed their body position; and activating the subset of the plurality of haptic vibrators to assist the user of the footbed system to match the change in body position of the user of the remote footbed system.

In Example 91, the subject matter of any one or more of Examples 84-90 optionally include wherein activating the subset of the plurality of haptic vibrators to provide haptic feedback comprises: activating the subset of the plurality of haptic vibrators using a lead time to allow the user of the footbed system to anticipate the change in the body position of the user of the remote footbed system.

In Example 92, the subject matter of Example 91 optionally includes wherein the lead time comprises a human reaction time component and an electronic transmission time component.

In Example 93, the subject matter of any one or more of Examples 84-92 optionally include determining that the user of the footbed system has fallen; and transmitting a distress call.

In Example 94, the subject matter of Example 93 optionally includes wherein determining that the user of the footbed system has fallen comprises: accessing accelerometer or pyrometer data to determine a change in acceleration or a change in orientation that indicates that the user of the footbed system has fallen.

In Example 95, the subject matter of any one or more of Examples 93-94 optionally include wherein transmitting the distress call comprises transmitting the distress call to the remote footbed system.

In Example 96, the subject matter of any one or more of Examples 93-95 optionally include wherein transmitting the distress call comprises transmitting the distress call to an emergency response system.

Example 97 is at least one machine-readable medium including instructions, which when executed by a machine, cause the machine to perform operations of any of the operations of Examples 1-96.

Example 98 is an apparatus comprising means for performing any of the operations of Examples 1-96.

Example 99 is a system to perform the operations of any of the Examples 1-96.

Example 100 is a method to perform the operations of any of the Examples 1-96.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B”, unless otherwise indicated. In the appended claims, the terms “including” and “in which” are used as the plain-English equivalents of the respective terms “comprising” and “wherein.” Also, in t following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A footbed system for activity instruction, the system comprising:
a support material;
a microcontroller embedded in the support material;
a plurality of force sensors coupled to the microcontroller, the force sensors disposed in the support material and configured to detect force applied via a foot of a user;
wherein the microcontroller is to:
obtain force sensor readings from the plurality of force sensors;
and
transmit the force sensor readings to a remote footbed system, the remote footbed system configured to receive the force sensor readings from the footbed system and provide haptic feedback to a user of the remote footbed system, the haptic feedback corresponding to locations of the force sensor readings in the footbed system.

2. The system of claim 1, wherein the microcontroller is to:
receive sensor information from the remote footbed system; and
activate haptic vibrators on the footbed system to alert the user of the footbed system of the sensor information from the remote footbed system.

3. The system of claim 2, wherein the sensor information indicates that the user of the remote footbed system collided with an object, fell, or is in distress.

4. The system of claim 1, wherein the microcontroller is to:
receive a distress signal from the remote footbed system; and
activate haptic vibrators on the footbed system to alert the user of the footbed system of the distress signal from the remote footbed system.

5. The system of claim 4, wherein to activate the haptic vibrators, the microcontroller is to:
activate all haptic vibrators in the footbed system.

6. A method of providing activity instruction, the method comprising:
obtaining, at a microcontroller, force sensor readings from a plurality of force sensors coupled to the microcontroller, the force sensors disposed in a support material of a footbed system, and configured to detect force applied via a foot of a user using the footbed system; and
transmitting the force sensor readings to a remote footbed system, the remote footbed system configured to receive the force sensor readings from the footbed system and provide haptic feedback to a user of the remote footbed system, the haptic feedback corresponding to locations of the force sensor readings in the footbed system.

7. The method of claim 6, further comprising:
receiving sensor information from the remote footbed system; and
activating haptic vibrators on the footbed system to alert the user of the footbed system of the sensor information from the remote footbed system.

8. The method of claim 7, wherein the sensor information indicates that the user of the remote footbed system collided with an object, fell, or is in distress.

9. The method of claim 6, further comprising:
receiving a distress signal from the remote footbed system; and
activating haptic vibrators on the footbed system to alert the user o the footbed system of the distress signal from the remote footbed system.

10. The method of claim 9, wherein activating the haptic vibrators comprises activating all haptic vibrators in the footbed system.

11. footbed system for ctivity instruction, the system comprising:
a support material;
a microcontroller embedded in the support material;
a plurality of haptic vibrators coupled to the microcontroller, the haptic vibrators disposed in the support material and configured to provide haptic feedback via a foot of a user;
wherein the microcontroller is to:
receive force sensor readings from a plurality of force sensors of a remote footbed system, the force sensor readings caused by a user of the remote footbed system changing their body position; and
activate a subset of the plurality of haptic vibrators to provide haptic feedback, the haptic feedback corresponding to locations of the force sensor readings in the remote footbed system.

12. The system of claim 11, wherein to activate the subset of the plurality of haptic vibrators to provide haptic feedback, the microcontroller is to:
determine that the user of the footbed system is approaching a corresponding position where the user of the remote footbed system changed their body position; and
activate the subset of the plurality of haptic vibrators to assist the user of the footbed system to match the change in body position of the user of the remote footbed system.

13. The system of claim 11, wherein to activate the subset of the plurality of haptic vibrators to provide haptic feedback, the microcontroller is to:
activate the subset of the plurality of haptic vibrators using a lead time to allow the user of the footbed system to anticipate the change in the body position of the user of the remote footbed system.

14. The system of claim 13, wherein the lead time comprises a human reaction time component and an electronic transmission time component.

15. The system of claim 11, wherein the microcontroller is to:
determine that the user of the footbed system has fallen; and
transmit a distress call.

16. The system of claim 15, wherein to determine that the user of the footbed system has fallen, the microcontroller is to:
access accelerometer or pyrometer data to determine a change in acceleration or a change in orientation that indicates that the user of the footbed system has fallen.

17. The system of claim 15, wherein to transmit the distress call, the microcontroller is to transmit the distress call to the remote footbed system.

18. The system of claim 17, wherein to transmit the distress call, the microcontroller is to transmit the distress call to an emergency response system.

19. A method of providing activity instruction, the method comprising:
receiving force sensor readings from a plurality of force sensors of a remote footbed system, the force sensor readings caused by a user of the remote footbed system changing their body position; and
activating a subset of the plurality of haptic vibrators to provide haptic feedback, the haptic vibrators disposed in a support material of a footbed system and configured to provide haptic feedback via a foot of a user; the haptic feedback corresponding to locations of the force sensor readings in the remote footbed system.

20. The method of claim 19, wherein activating the subset of the plurality of haptic vibrators to provide haptic feedback comprises:
activating the subset of the plurality of haptic vibrators using a lead time to allow the user of the footbed system to anticipate the change in the body position of the user of the remote footbed system.

21. At least one non-transitory machine-readable medium including instructions for providing activity instruction, which when executed by a machine, cause the machine to perform the operations comprising:
receiving force sensor readings from a plurality of force sensors of a remote footbed system, the force sensor readings caused by a user of the remote footbed system changing their body position; and
activating a subset of the plurality of haptic vibrators to provide haptic feedback, the haptic vibrators disposed in a support material of a footbed system and configured to provide haptic feedback via a foot of a user; the haptic feedback corresponding to locations of the force sensor readings in the remote footbed system.

22. The at least one machine-readable medium of claim 21, further comprising:
determining a geographic location of the footbed system.

23. The at least one machine-readable medium of claim 22, wherein determining the geographic location comprises determining the geographic location with a positioning system.

24. The at least one machine-readable medium of claim 21. wherein activating the subset of the plurality of haptic vibrators to provide haptic feedback, comprises:
determining that the user of the footbed system is approaching a corresponding position where the user of the remote footbed system changed their body position; and
activating the subset of the plurality of haptic vibrators to assist the user of the footbed system to match the change in body position of the user of the remote footbed system.

25. The at least one machine-readable medium of claim 21, wherein activating the subset of the plurality of haptic vibrators to provide haptic feedback comprises:
activating the subset of the plurality of haptic vibrators using a lead time to allow the user of the footbed system to anticipate the change in the body position of the user of the remote footbed system.
